(19) United States
(12) Patent Application Publication
(10) Pub. No.: US 2026/0227799 A1
(43) Pub. Date: Aug. 6, 2026

(54) UNMANNED AERIAL VEHICLE ENERGY HARVESTING

(71) Applicant: QUALCOMM Incorporated, San Diego, CA (US)

(72) Inventors: Kangqi LIU, San Diego, CA (US); Mingxi YIN, Beijing (CN); Hao XU, Beijing (CN); Ruiming ZHENG, Beijing (CN); Chao WEI, Beijing (CN)

(21) Appl. No.: 19/146,326

(22) PCT Filed: Feb. 22, 2023
(86) PCT No.: PCT/CN2023/077546

§ 371 Date: Jul. 8, 2025

(51) Int. Cl. G05D 1/656; G05D 109/25

(52) U.S. Cl. CPC G05D 1/656; G05D 2109/254

(57) ABSTRACT

Various aspects of the present disclosure generally relate to wireless communication. In some aspects, a user equipment (UE) may transmit an energy harvesting (EH) request to a first network node based on the UE having a battery charge below a threshold associated with an original travel path. The UE may receive an updated travel path, wherein the updated travel path includes an EH charging location. Numerous other aspects are described.

### FIELD OF THE DISCLOSURE

Aspects of the present disclosure generally relate to wireless communication and to techniques and apparatuses for energy harvesting for unmanned aerial vehicles.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include transmitting an energy harvesting (EH) request to a first network node based on the UE having a battery charge below a threshold associated with an original travel path. The method may include receiving an updated travel path, wherein the updated travel path includes an EH charging location.

Some aspects described herein relate to a method of wireless communication performed by a network node. The method may include receiving an EH request from a UE, the EH request indicating that the UE has a battery charge below a threshold associated with an original travel path. The method may include outputting or configuring an updated travel path, wherein the updated travel path includes an EH charging location.

Some aspects described herein relate to a UE for wireless communication. The UE may include a memory and one or more processors coupled to the memory. The one or more processors may be configured to transmit an EH request to a first network node based on the UE having a battery charge below a threshold associated with an original travel path. The one or more processors may be configured to receive an updated travel path, wherein the updated travel path includes an EH charging location.

Some aspects described herein relate to a network node for wireless communication. The network node may include a memory and one or more processors coupled to the memory. The one or more processors may be configured to receive an EH request from a UE, the EH request indicating that the UE has a battery charge below a threshold associated with an original travel path. The one or more processors may be configured to output or configure an updated travel path, wherein the updated travel path includes an EH charging location.

Some aspects described herein relate to a non-transitory computer-readable medium that stores a set of instructions for wireless communication by a UE. The set of instructions, when executed by one or more processors of the UE, may cause the UE to transmit an EH request to a first network node based on the UE having a battery charge below a threshold associated with an original travel path. The set of instructions, when executed by one or more processors of the UE, may cause the UE to receive an updated travel path, wherein the updated travel path includes an EH charging location.

Some aspects described herein relate to a non-transitory computer-readable medium that stores a set of instructions for wireless communication by a network node. The set of instructions, when executed by one or more processors of the network node, may cause the network node to receive an EH request from a UE, the EH request indicating that the UE has a battery charge below a threshold associated with an original travel path. The set of instructions, when executed by one or more processors of the network node, may cause the network node to output or configure an updated travel path, wherein the updated travel path includes an EH charging location.

Some aspects described herein relate to an apparatus for wireless communication. The apparatus may include means for transmitting an EH request to a first network node based on the UE having a battery charge below a threshold associated with an original travel path. The apparatus may include means for receiving an updated travel path, wherein the updated travel path includes an EH charging location.

Some aspects described herein relate to an apparatus for wireless communication. The apparatus may include means for receiving an EH request from a UE, the EH request indicating that the UE has a battery charge below a threshold associated with an original travel path. The apparatus may include means for outputting or configuring an updated travel path, wherein the updated travel path includes an EH charging location.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by drawings and specification; and/or an apparatus comprising means for performing the aforementioned methods and/or those described herein with reference to and as illustrated by drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example BS and UE, in accordance with the present disclosure.

FIG. 3 depicts an example disaggregated base station architecture, in accordance with the present disclosure.

FIGS. 4A-4D depict aspects of data structures for a wireless communications network, such as the wireless communications network of FIG. 1, in accordance with the present disclosure.

FIG. 5 is a diagram illustrating an example of unmanned aerial vehicles (UAVs) within a wireless communication network environment, in accordance with the present disclosure.

FIGS. 6A-6D are diagrams illustrating an example associated with energy harvesting for UAVs, in accordance with the present disclosure.

FIG. 7 is a diagram of an example associated with energy harvesting for UAVs, in accordance with the present disclosure.

FIG. 8 is a diagram of an example associated with energy harvesting for UAVs, in accordance with the present disclosure.

FIG. 9 shows a method for wireless communications by a UE, in accordance with the present disclosure.

FIG. 10 shows a method for wireless communications by a network entity, in accordance with the present disclosure.

FIG. 11 is a diagram illustrating an example of an implementation of code and circuitry for a communications device, in accordance with the present disclosure.

FIG. 12 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for energy harvesting for unmanned aerial vehicles.

Unmanned aerial vehicles (UAVs) can be used as a delivery platform. The distance that a UAV is able to travel, however, may be limited by various factors such as a battery size of the UAV, a weight of a package carried by the UAV, a combination thereof, and/or the like. For a given delivery distance and battery size, the UAV will only be able to carry a package having a maximum weight or the battery will need to be recharged at some point during the delivery. Likewise, for a given package weight and battery size, the UAV will only be able to travel a certain distance before the battery must be recharged. If the UAV is unable to deliver the package on a single battery charge, the UAV must stop at charging stations, which may not be along the UAV's route. Building such charging stations is expensive and time consuming.

One solution involves charging UAVs using existing infrastructure as dedicated energy harvesting (EH) nodes. For example, one or more existing network entities, such as next generation NodeB (gNB) base stations, may be configured to charge UAVs through an EH charging process. In another possible implementation, one or more gNBs may be designated as EH network nodes to charge UAVs. For example, when a UAV does not have a sufficient battery charge to reach its destination, it may navigate to a nearby EH network node for charging. In another possible implementation, the UAV may navigate a modified route to pass near one or more EH network nodes for charging.

Accordingly, the UAV may reach its destination and deliver the package despite the package being too heavy and/or the distance being too far given the size of the battery, the battery state of charge, a combination thereof, and/or the like.

Moreover, because certain aspects of the foregoing approaches rely on existing network infrastructure for EH charging, charging locations may be more readily available to the UAV, which can reduce the distance the UAV must travel off its current route to charge the battery.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

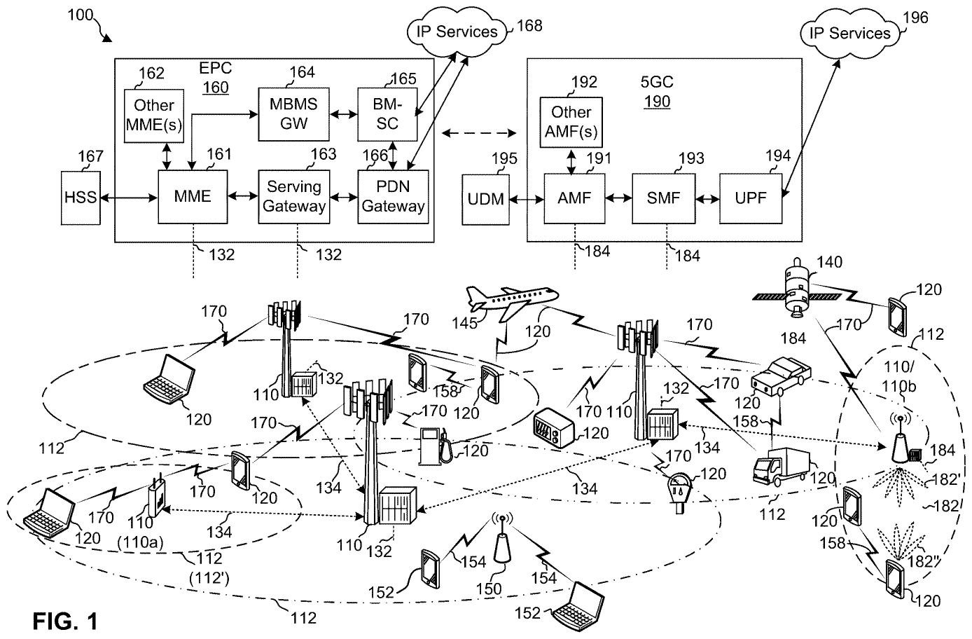

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IOT) device, an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

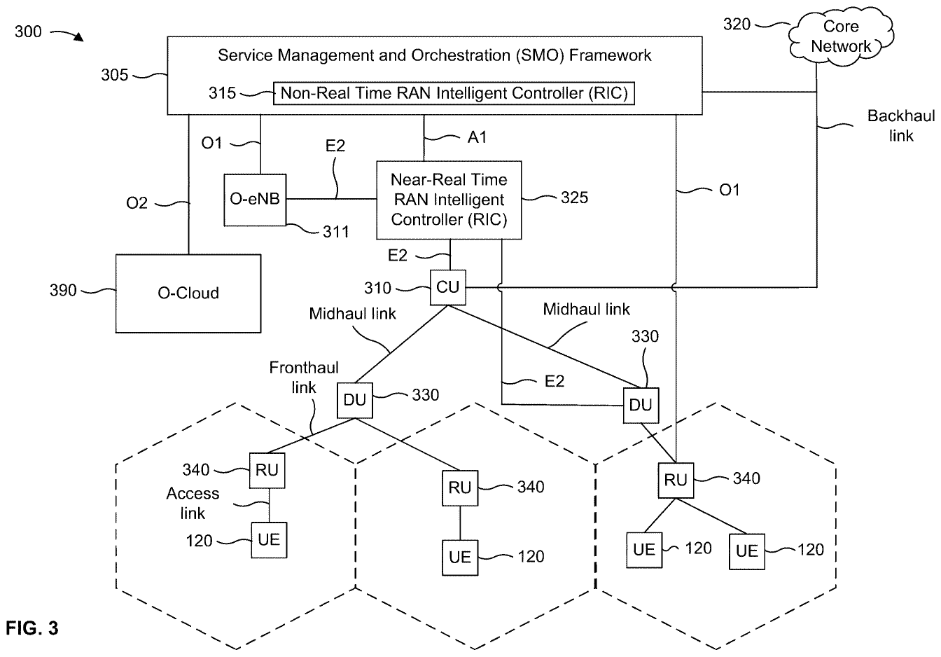

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHZ- 7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mm Wave or near mm Wave radio frequency bands (e.g., a mm Wave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110 b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

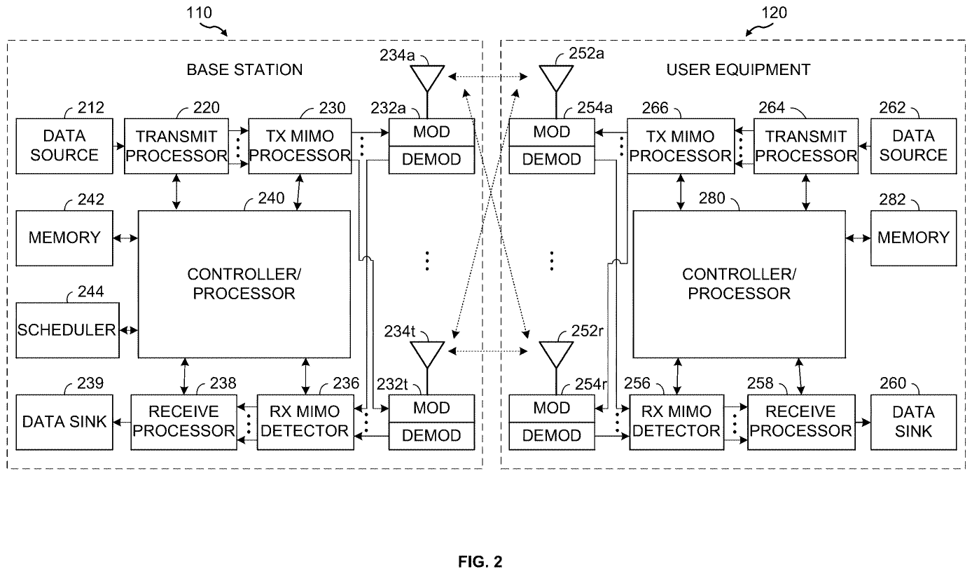

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for single-carrier frequency division multiplexing (SC-FDM)), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, receive (RX) MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base-station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units.

Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an Ol interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as Al policies).

As indicated above, FIG. 3 is provided as an example. Other examples may differ from what is described with regard to FIG. 3.

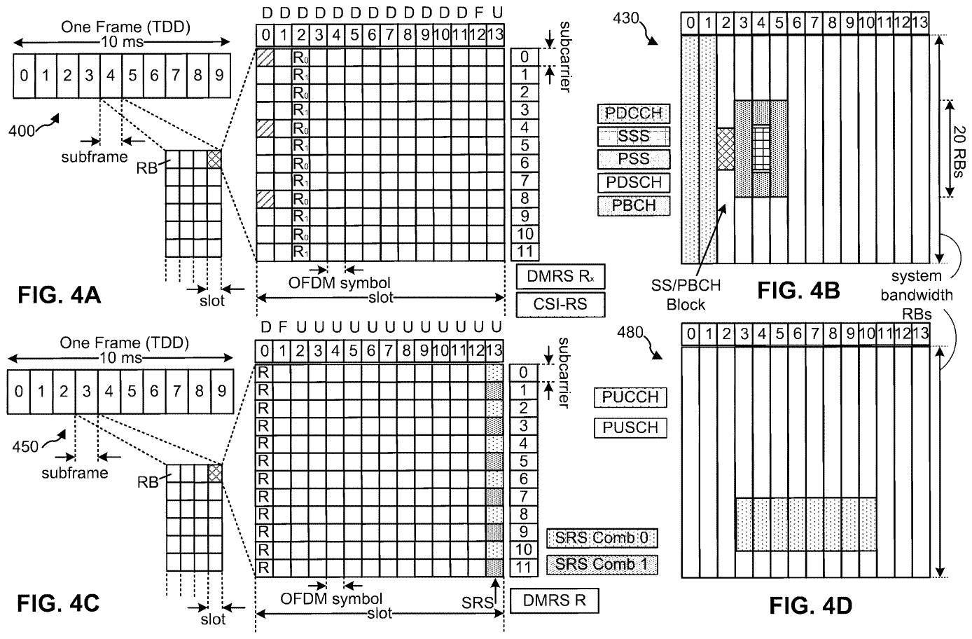

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 24^{μ}×15 kHz, where u is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

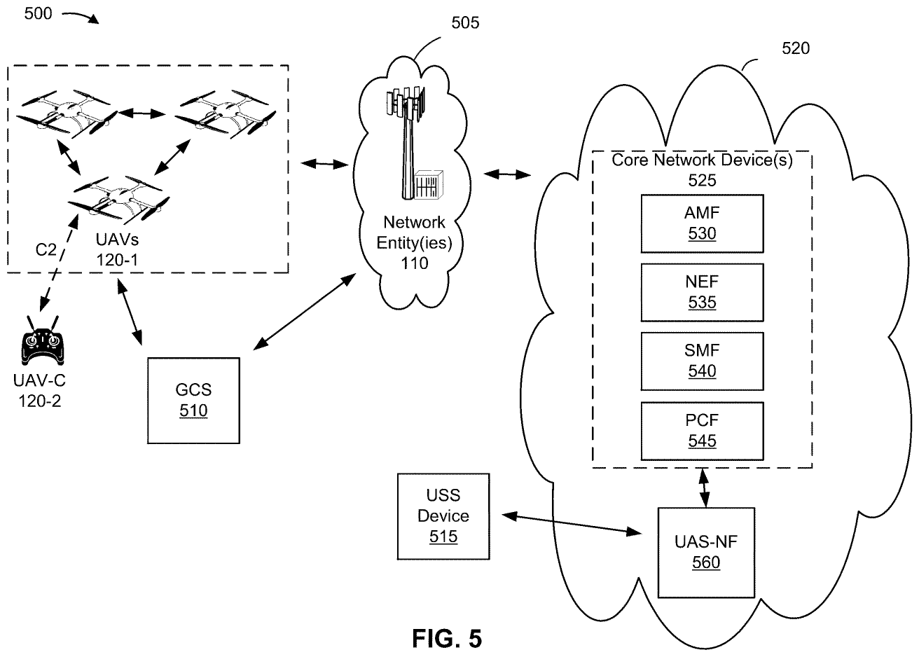

FIG. 5 is a diagram illustrating an example of unmanned aerial vehicle (UAV) UEs 120 within a wireless communication network environment 500, in accordance with the present disclosure. As shown in FIG. 5, the environment 500 can include one or more UEs 120, which may include one or more UAVs 120-1 and one or more UAV controllers (UAV-Cs) 120-2, a RAN 505, a core network 520, a UAV service supplier (USS) device 515, and a ground control system (GCS) 510. Devices of environment 500 can interconnect via wired connections, wireless connections, or a combination of wired and wireless connections.

The UAV 120-1 (also referred to herein as a UAV UE 120-1) may include an aircraft without a human pilot aboard and can also be referred to as an unmanned aircraft (UA), a drone, a remotely piloted vehicle (RPV), a remotely piloted aircraft (RPA), a remotely operated aircraft (ROA), or an uncrewed aerial vehicle. The UAV 120-1 may have a variety of shapes, sizes, configurations, characteristics, or the like for a variety of purposes and applications. In some examples, the UAV 120-1 may include one or more sensors, such as an electromagnetic spectrum sensor (e.g., a visual spectrum, infrared, or near infrared camera, a radar system, or the like), a biological sensor, a temperature sensor, and/or a chemical sensor, among other examples. In some examples, the UAV 120-1 may include one or more components for communicating with one or more network nodes 110. Additionally, or alternatively, the UAV 120-1 may transmit information to and/or receive information from the GCS 510, such as sensor data, flight plan information, or the like. Such information can be communicated directly (e.g., via an RRC signal and/or the like) and/or via the network node(s) 110 on the RAN 505. The UAV 120-1 may be a component of an unmanned aircraft system (UAS). The UAS may include the UAV 120-1, a UAV-C 120-2 (also referred to herein as a UAV-C UE 120-2), and a system of communication (such as wireless network environment 500 or another system of communication) between the UAV 120-1 and the UAV-C 120-2.

The RAN 505 may include one or more network nodes 110 that provide access for the UAV UEs 120 to the core network 520. For example, the RAN 505 may include one or more aggregated network nodes and/or one or more disaggregated network nodes (e.g., including one or more CUs, one or more DUs, and/or one or more RUs). The UAV 120-1 may communicate with the network nodes 110 via the Uu interface. For example, the UAV 120-1 may transmit communications to a network entity 110 and/or receive communications from the network entity 110 via the Uu interface. Such Uu connectivity may be used to support different applications for the UAV 120-1, such as video transmission from the UAV 120-1 or C2 communications for remote command and control of the UAV 120-1, among other examples.

The GCS 510 may include one or more devices capable of managing the UAV 120-1 and/or flight plans for the UAV 120-1. For example, the GCS 510 may include a server device, a desktop computer, a laptop computer, or a similar device. In some examples, the GCS 510 may communicate with one or more devices of the environment 500 (e.g., the UAV 120-1, the USS device 515, and/or the like) to receive information regarding flight plans for the UAV UEs 120-1 and/or to provide recommendations associated with such flight plans, as described elsewhere herein. In some examples, the GCS 510 may permit a user to control one or more of the UAVs 120-1 (e.g., via the UAV-C 120-2). Additionally, or alternatively, the GCS 510 can use a neural network and/or other artificial intelligence (AI) to control one or more of the UAVs 120-1. In some examples, the GCS 510 may be included in a data center, a cloud computing environment, a server farm, or the like, which may include multiple GCSs 510. While shown as being external from the core network 520 in FIG. 5, in some aspects, the GCS 510 may reside at least partially within the core network 520.

The USS device 515 includes one or more devices capable of receiving, storing, processing, and/or providing information associated with the UAV UEs 120 and/or the GCS 510. For example, the USS device 515 can include an application server, a desktop computer, a laptop computer, a tablet computer, a mobile phone, or a similar device. In some examples, the UAVs 120-1 can interact with the USS device 515 to register a flight plan, receive approval, analysis, and/or recommendations related to a flight plan, or the like. The USS device 515 may register the UAV UE 120 with the USS device 515 by assigning an application-level UAV identifier to the UAV UE 120. The application-level UAV identifier may be an aviation administration (e.g., a regulatory body that governs aviation operation in a jurisdiction in which the USS device 515 and the UAV UE 120 are operating) UAV identifier.

The core network 520 includes a network that enables communications between the RAN 505 (e.g., the network node(s) 110) and one or more devices and/or networks connected to the core network 520. For example, the core network 520 may be a 5G core network. The core network 520 may include one or more core network devices 525, such as one or more access and mobility management functions (AMFs) (herein after referred to as an “AMF”) 530, one or more network exposure functions (NEFs) herein after referred to as an “NEF”) 535, one or more session management functions (SMFs) (herein after referred to as an “SMF”) 540, one or more policy control functions (PCFs) (herein after referred to as a “PCF”) 545, and/or other entities and/or functions that provide mobility functions for the UAV UEs 120 and enable the UAV UEs 120 to communicate with other devices of the environment 500.

The AMF 530 may include one or more network devices, such as one or more server devices, capable of managing authentication, activation, deactivation, and/or mobility functions associated with the UAV UE 120 connected to the core network 520. In some examples, the AMF 530 may perform operations relating to authentication of the UAV 120-1. The AMF 530 may maintain a non-access stratum (NAS) signaling connection with the UAV 120-1.

The NEF 535 may include one or more network exposure devices, such as one or more server devices, capable of exposing capabilities, events, information, or the like in one or more wireless networks to help other devices in the one or more wireless networks discover network services and/or utilize network resources efficiently. In some examples, the NEF 535 may receive traffic from and/or send traffic to the UAV 120-1 via the AMF 530 and the network entity 110, and the NEF 535 may receive traffic from and/or send traffic to the USS device 515 via a UAS network function (UAS-NF) 560. In some examples, the NEF 535 may obtain a data structure, such as approval of a flight plan for the UAV 120-1, from the USS device 515 and divide the data structure into a plurality of data segments. In some examples, the NEF 535 may determine a location and/or reachability of the UAV 120-1 and/or a communication capability of the network entity 110 to determine how to send the plurality of data segments to the UAV 120-1.

The SMF 540 may include one or more network devices, such as one or more server devices, capable of managing sessions for the RAN 505 and allocating addresses, such as Internet protocol (IP) addresses, to the UAVs 120-1. In some examples, the SMF 540 may perform operations relating to registration of the UAV 120-1. For example, the AMF 530 may receive a registration request from the UAV 120-1 and forward a request to the SMF 540 to create a corresponding packet data unit (PDU) session. The SMF 540 may allocate an address to the UAV 120-1 and establish the PDU session for the AMF 530.

The PCF 545 may include one or more network devices, such as one or more server devices, capable of managing traffic to and from the UAV UEs 120 through the RAN 505 and enforcing a QoS on the RAN 505. In some examples, the PCF 545 may implement charging rules and flow control rules, manage traffic priority, and/or manage a QoS for the UAVs 120-1.

The USS device 515 may communicate with the core network 520 using the UAS-NF 560. The UAS-NF 560 may be a service-based interface to enable the USS device 515 to provide information to the core network 520. For example, the USS device 515 may provide, via the UAS-NF 560, registration information associated with a registration between the UAV 120-1 and the USS device 515. The UAS-NF 560 may include a device, such as a server device, that is external to the core network 520, or the UAS-NF 560 may reside, at least partially, on a core network device 525 within the core network 520. In some aspects, the UAS-NF 560 may be co-located with the NEF 535. In some aspects, or more of the core network device(s) 525 and/or the UAS-NF 560 may correspond to network controller 130, as described above in connection with FIG. 1.

The UAV-C 120-2 may remotely control the UAV 120-2 by transmitting C2 communications to the UAV 120-1 and/or receiving C2 communications from the UAV 120-1. In some examples, the UAV-C 120-2 and the UAV 120-1 may use the Uu interface for the C2 communications. For example, the UAV-C 120-2 may transmit C2 communications to UAV 120-1 (and receive C2 communications from the UAV 120-1) via the network entity 110. In some examples, the UAV-C 120-2 and the UAV 120-1 may use a non-cellular communication system (e.g., non-3GPP connectivity), such as wireless fidelity (Wi-Fi), for the C2 communications.

As indicated above, FIG. 5 is provided as an example. Other examples may differ from what is described with respect to FIG. 5.

UAVs can be used as a delivery platform. The distance the UAV is able to travel, however, may be limited by various factors such as a battery size of the UAV, the weight of the package carried by the UAV, a combination thereof, and/or the like. For a given delivery distance and battery size, the UAV will only be able to carry a package having a maximum weight or the battery will need to be recharged at some point during the delivery. Likewise, for a given package weight and battery size, the UAV will only be able to travel a certain distance before the battery must be recharged. If the UAV is unable to deliver the package on a single battery charge, the UAV must stop at charging stations, which may not be along the UAV's route. Therefore, to complete the delivery, the UAV may need to stop at charging stations located along the route. Building such charging stations is expensive and time consuming.

In some instances, UAVs can be charged while traveling to a destination through an EH process using existing infrastructure. For example, one or more existing network entities may be configured to charge UAVs (or facilitate charging of the UAV) through the EH process. Examples of existing network entities that may be involved in the EH process include gNBs. The gNBs involved in the EH process may be categorized as type-0, type-1, or type 2, gNBs. A type-0 gNB may be a legacy gNB that is not configured to perform any EH processes. A type-0 gNB, however, may direct the UAV to a different gNB, such as a type-1 gNB or a type-2 gNB. A type-1 gNB may perform EH processes to charge the UAV but not perform other operations typically associated with a gNB. In other words, a type-1 gNB may be available only for EH purposes. A type-2 gNB may be configured to perform the same functions as a legacy gNB while also performing EH processes to charge the UAV.

In some aspects, one or more gNBs may be designated as EH network nodes to charge UAVs or facilitate the charging of UAVs. For example, when a UAV does not have a sufficient battery charge to reach its destination, it may navigate to an EH network entity (either a type-1 gNB or a type-2 gNB) for charging. In another possible implementation, the UAV may navigate a modified route to pass near one or more EH network entities (e.g., one or more type-1 or type-2 gNBs) for charging.

Some techniques and apparatuses described herein provide for a UE to transmit an EH request to a first network node based on the UE having a battery charge below a threshold associated with an original travel path; and receive an updated travel path, wherein the updated travel path includes an EH charging location. By modifying the travel path so the UE can charge along the route, the UE may reach its destination and deliver the package despite the package being too heavy and/or the distance being too far given the size of the battery, the battery state of charge, a combination thereof, and/or the like.

Some techniques and apparatuses described herein provide for a network node to receive an EH request from a UE, the EH request indicating that the UE has a battery charge below a threshold associated with an original travel path; and output or configure an updated travel path, wherein the updated travel path includes an EH charging location. Having the network node provide an EH process allows for charging locations to be more readily available to the UE, which can reduce the distance the UE must deviate from the travel path to charge the battery.

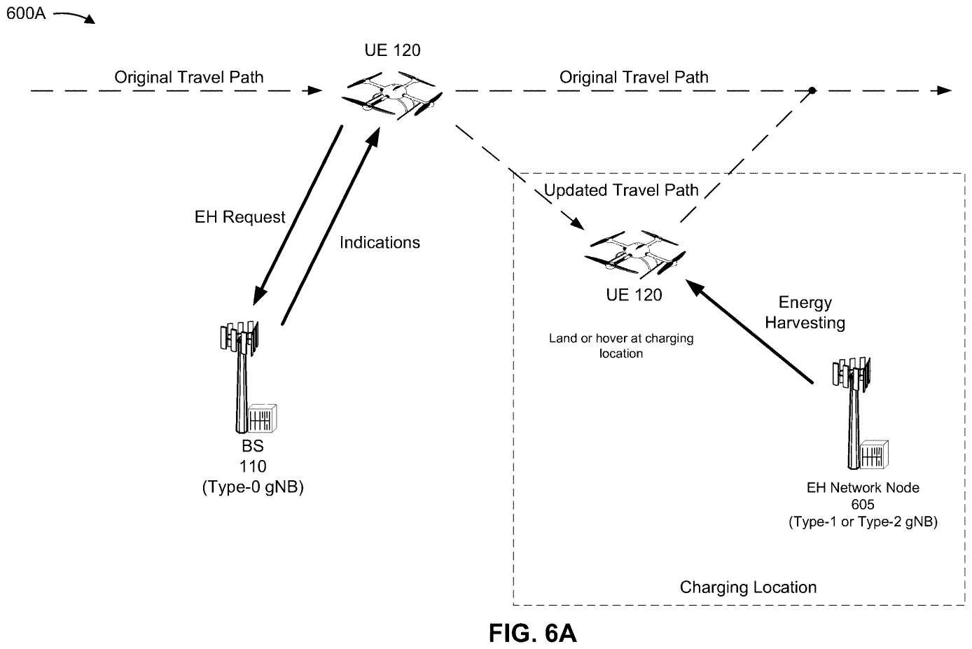

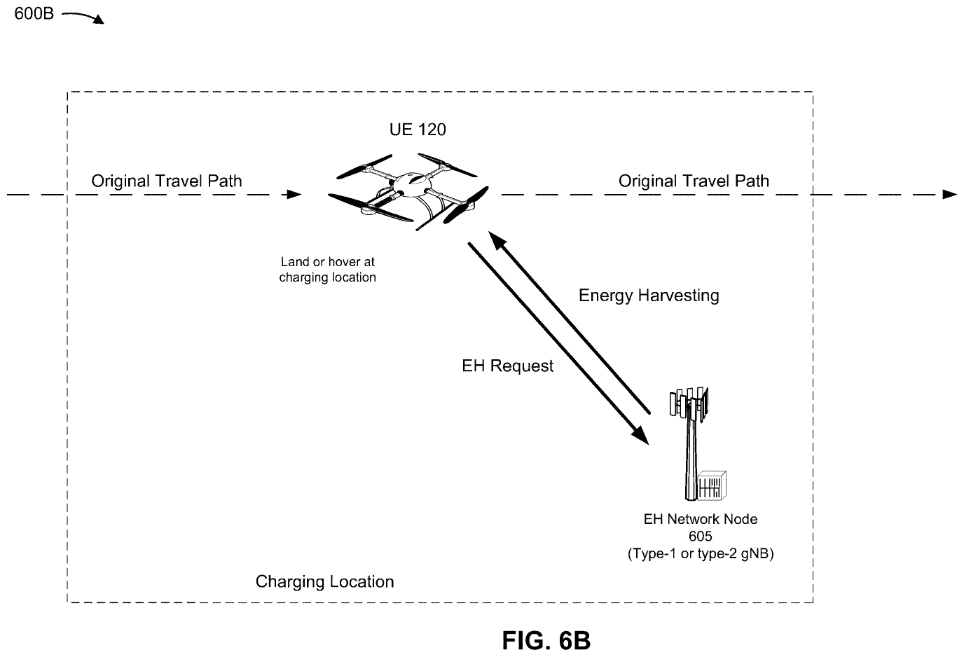

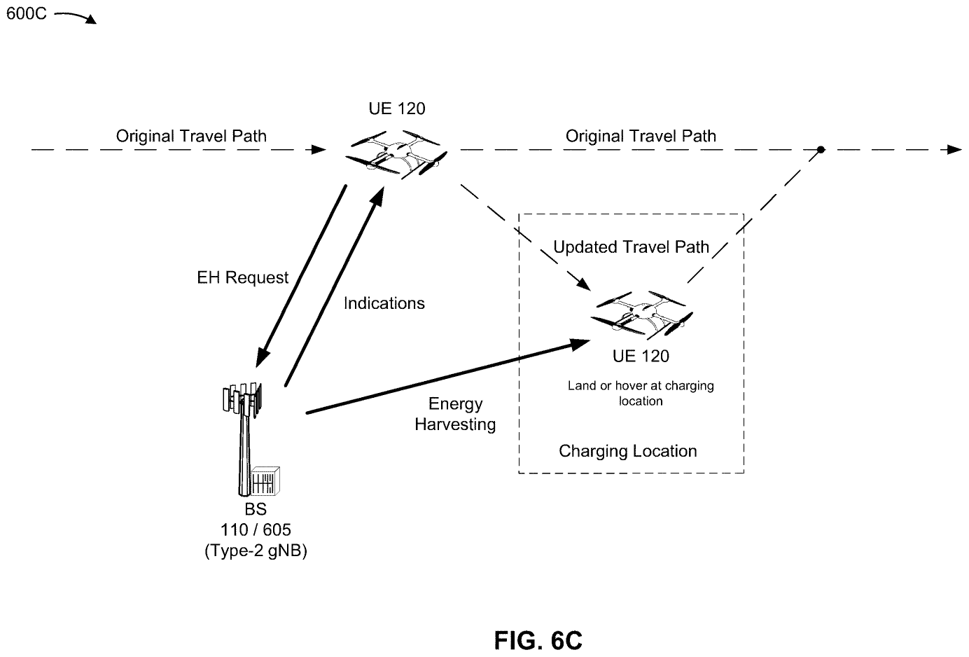

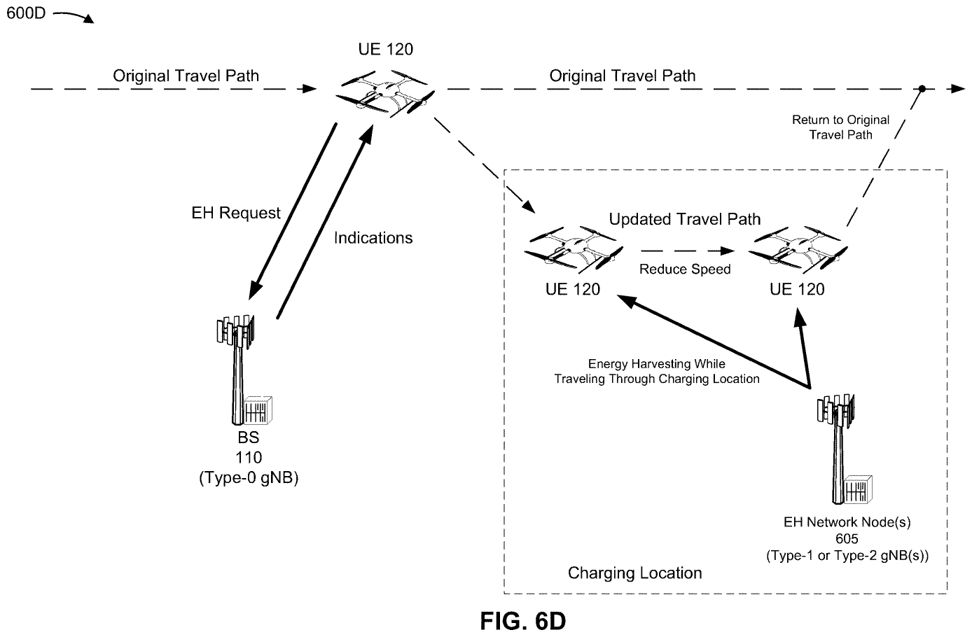

FIG. 6A is a diagram illustrating an example 600A associated with static energy harvesting for UAVs, in accordance with the present disclosure. As shown in FIG. 6A, example 600A includes communication between BS 110, EH network node 605, which may be a BS such as a type-1 or type-2 gNB, and a UE 120 (shown as a UAV UE). In some aspects, BS 110, EH network node 605, and UE 120 may be included in a wireless network, such as wireless network 100. BS 110, EH network node 605, and UE 120 may communicate via a wireless access link, which may include an uplink and a downlink.

As shown, the UE 120 transmits an EH request to the BS 110. In some aspects, the BS 110 is a type-0 gNB and therefore unable to perform an EH charging process to charge the UE 120. In this example, the BS 110 configures, via the indications, the UE 120 with an updated travel path so the UE 120 may travel to an EH charging location associated with the EH network node 605, which is different from the BS 110. When the UE 120 arrives at the EH charging location, an EH charging process occurs between the UE 120 and the EH network node 605. When the EH charging process is complete, the UE 120 may return to the original travel path and resume travel to the original destination.

As indicated above, FIG. 6A is provided as an example. Other examples may differ from what is described with respect to FIG. 6A.

FIG. 6B is a diagram illustrating an example 600B associated with static energy harvesting for UAVs, in accordance with the present disclosure. As shown in FIG. 6B, example 600B includes communication between EH network node 605, which may be a BS such as a type-1 or type-2 gNB, and a UE 120 (shown as a UAV UE). In some aspects, EH network node 605 and UE 120 may be included in a wireless network, such as wireless network 100. EH network node 605 and UE 120 may communicate via a wireless access link, which may include an uplink and a downlink.

As shown in FIG. 6B, the original travel path takes the UE 120 near EH network node 605, which can perform the EH process for the UE 120. In this example, the UE 120 transmits an EH request to the EH network node 605 upon arrival at the EH charging location. The EH network node 605 may provide instructions for the UE 120 to hover or land near or at the location of the EH network node 605 during the EH process. The instructions to hover or land near or at the location of the EH network node 605 may be considered an “updated travel path.” Upon completion of the EH charging process, the UE 120 may return to and/or continue along the original travel path.

As indicated above, FIG. 6B is provided as an example. Other examples may differ from what is described with respect to FIG. 6B.

FIG. 6C is a diagram illustrating an example 600C associated with static energy harvesting for UAVs, in accordance with the present disclosure. As shown in FIG. 6C, example 600C includes communication between EH network node 605, which may be a BS such as a type-2 gNB, and a UE 120 (shown as a UAV UE). In some aspects, EH network node 605 and UE 120 may be included in a wireless network, such as wireless network 100. EH network node 605 and UE 120 may communicate via a wireless access link, which may include an uplink and a downlink.

As shown, the UE 120 transmits an EH request to the EH network node 605. In this example, the EH network node 605 configures, via the indications, the UE 120 with an updated travel path so that the UE 120 may travel to an EH charging location associated with the EH network node 605. When the UE 120 arrives at the EH charging location, the UE 120 lands or hovers at the EH charging location, and an EH charging process occurs between the UE 120 and the EH network node 605. When the EH charging process is complete, the UE 120 may return to the original travel path and resume travel to the original destination.

As indicated above, FIG. 6C is provided as an example. Other examples may differ from what is described with respect to FIG. 6C.

FIG. 6D is a diagram illustrating an example 600D associated with dynamic energy harvesting for UAVs, in accordance with the present disclosure. As shown in FIG. 6D, example 600D includes communication between BS 110, one or more EH network node 605, which may be BSs such as a type-1 or type-2 gNBs, and a UE 120 (shown as a UAV UE). In some aspects, BS 110, the EH network nodes 605, and UE 120 may be included in a wireless network, such as wireless network 100. BS 110, the EH network nodes 605, and UE 120 may communicate via a wireless access link, which may include an uplink and a downlink.

As shown, the UE 120 transmits an EH request to the BS 110. In some aspects, the BS 110 is a type-0 gNB and therefore unable to perform an EH charging process to charge the UE 120. In some aspects, the BS is a type-1 or type-2 gNB but not close enough to the UE 120 to charge the UE 120 via the EH charging process. The BS 110 configures, via the indications, the UE 120 with an updated travel path so the UE 120 may travel to one or more EH charging locations having one or more EH network nodes 605, which may be different from the BS 110. When the UE 120 arrives at the EH charging location, an EH charging process occurs between the UE 120 and the EH network node 605. Rather than hovering or landing at or near the EH network node 605, the UE 120 may receive a charge via the EH process by flying near the one or more EH network nodes 605. In some aspects, the UE 120 may reduce its speed while traveling in the EH charging location(s). When the EH charging process is complete, the UE 120 may return to the original travel path and speed, and resume travel to the original destination.

As indicated above, FIG. 6D is provided as an example. Other examples may differ from what is described with respect to FIG. 6D.

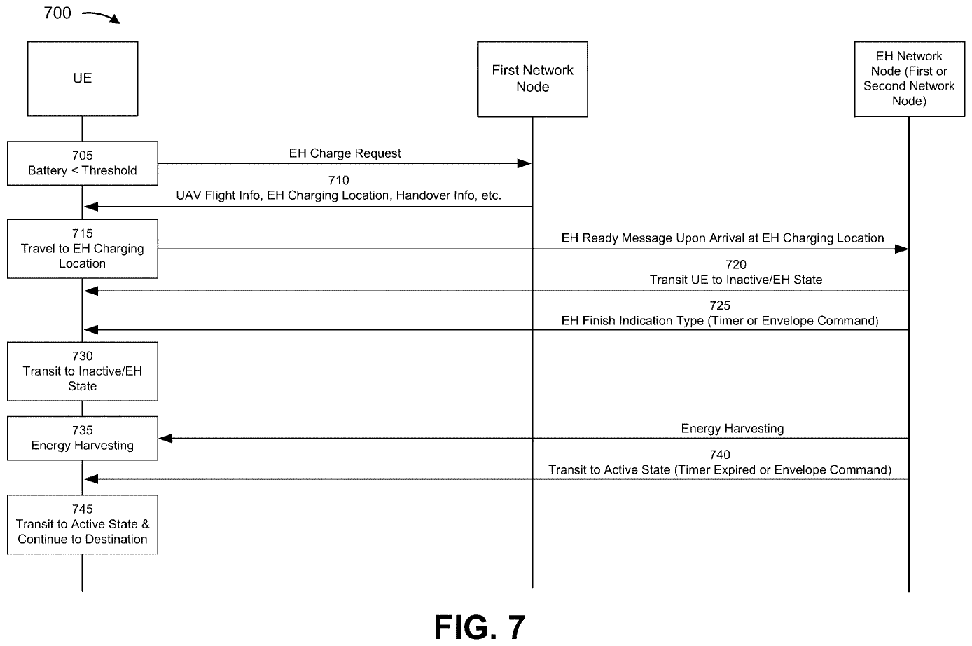

FIG. 7 is a diagram of an example 700 associated with energy harvesting for UAVs, in accordance with the present disclosure. As shown in FIG. 7, one or more network nodes may communicate with a UE (e.g., UAV UE 120). The multiple network nodes may include one or more base stations 110, one or more CUs, one or more DUs, one or more RUs, one or more core network nodes, one or more network servers, one or more application servers, and/or one or more access and mobility management functions (AMFs), among other examples. In some aspects, the UE and a first network node of the multiple network nodes may be part of a wireless network (e.g., wireless network 100). The UE and the first network node may have established a wireless connection prior to operations shown in FIG. 7.

As shown by reference number 705, the UE may determine that a battery charge is below a threshold and transmit an EH charge request. The threshold may be a value indicating the amount of battery charge needed for the UE to travel to a destination along the original travel path. In some aspects, the threshold may further indicate the amount of battery charge needed for the UE to travel to the destination along the original travel path with a payload having a particular weight. In some aspects, the threshold may further indicate the amount of battery charge needed to travel to and/or return from the destination. In some aspects, the threshold may be a value greater than a value indicating a full battery charge, indicating that EH charging will need to occur at some point for the UE to reach the destination and/or return from the destination. The first network node may receive the EH charge request.

As shown by reference number 710, the first network node may output, and the UE may receive, information in response to the EH charge request. The information may include an updated travel path, the identification of the EH charging location, handover information if, for example, the EH charging process will be performed by a different network node, such as a second network node of the multiple network nodes, and/or a combination thereof, or the like.

As shown by reference number 715, the UE may travel to the EH charging location received via the information indicated at reference number 710. In implementations where the UE is a UAV, the UE may fly to the EH charging location along the updated travel path configured by the first network node. In implementations where the UE is a terrestrial vehicle, such as a personal or commercial automobile, truck, an autonomous vehicle, and/or the like, the UE may drive or navigate to the EH charging location along the updated travel path. Upon arrival at the EH charging location, the UE may transmit an EH ready message to the network node at the EH charging location (referred to as the “EH network node”) that will perform the EH charging process. In some aspects, the EH network node is the first network node. The EH network node may be the first network node if the first network node is a type-1 or type-2 gNB. In some aspects, the EH network node is the second network node. The EH network node may be the second network node if the first network node is a type-0 gNB. In some aspects, the EH network node may be the second network node if the first network node is too far from the original travel path. For example, even if the first network node is a type-1 or type-2 gNB, in some instances, the UE may be able to charge and arrive at the destination faster by traveling to the second network node rather than by traveling to the first network node. This may occur if, for example, the UE has already passed the first network node and returning to the first network node for the EH charging process would take more time than proceeding to the second network node for the EH charging process.

As shown by reference number 720, the EH network node may configure and output, and the UE may receive, signaling that causes the UE to operate in an inactive or EH state. In some aspects, the signaling configured and output by the EH network node to cause the UE to operate in the inactive or EH state may include RRC signaling.

Certain functionality of the UE may be limited while the UE is operating in the inactive or EH state. For example, certain UL and DL communications to and from the UE may be limited while the UE is operating in the inactive or EH state. In some aspects, mobility of the UE may be limited while the UE is operating in the inactive or EH state. For example, the UE may be limited to traveling at a lower speed or prevented from traveling altogether while operating in the inactive or EH state. In some aspects, the UE may be configured to land or hover at the EH charging location while operating in the inactive or EH state.

As shown by reference number 725, the EH network node may output, and the UE may receive, an EH finish indication type. The EH finish indication type may indicate to the UE how the EH charging process will end. In some aspects, the EH network node will perform the EH charging process for a predetermined amount of time. In that example, the EH finish indication type may include a timer length value indicating a charging time period. Alternatively, in some aspects, the UE may transmit, and the EH network node may receive, the timer length value indicating the charging time period. In some aspects, the EH finish indication type may include an energy envelope command output by the EH network node to indicate that the EH charging process is complete.

As shown by reference number 730, the UE transitions to the inactive or EH state. The UE may configure itself to operate in the inactive or EH state based at least in part on the configuration signaling received at reference number 720. As discussed above, certain functionality of the UE may be limited while the UE is operating in the inactive or EH state.

As shown by reference number 735, the UE and the EH network node may begin the EH charging process. During the EH charging process, energy output by the EH network node wirelessly charges the battery of the UE. The EH charging process may continue until the battery of the UE is fully charged, until an amount of time indicated by the timer length value has elapsed, or the UE and/or the EH network node otherwise discontinue the EH charging process.

As shown by reference number 740, the EH network node may output, and the UE may receive, configuration signaling to transition to an active state. The configuration signaling may occur consistently with the EH finish indication type discussed above with reference to reference number 725. For example, in some aspects, the EH network node may output the signaling to transition the UE to the active state when the amount of time indicated by the timer length value has elapsed. In some aspects, the EH network node may output the energy envelope command indicating that the EH charging process is complete. In some aspects, the configuration signaling may be RRC signaling.

As shown by reference number 745, the UE may transition from the inactive or EH state to the active state. In some aspects, the UE may configure itself to operate in the active state in response to the configuration signaling received at reference number 740. When operating in the active state, the UE may continue to the destination of the original travel path. In some aspects, the UE may return to the original travel path before continuing to the destination. In some aspects, the UE may proceed along a

With the above approach, the UE has an opportunity to charge its battery and reach its target destination. Accordingly, the UE can travel farther than if it were limited to a range associated with a single battery charge. Moreover, by transitioning to an inactive or EH state, the UE can use less energy during the EH charging process, which may permit the UE to charge faster than if it were operating at full functionality (e.g., the active state).

As indicated above, FIG. 7 is provided as an example. Other examples may differ from what is described with respect to FIG. 7.

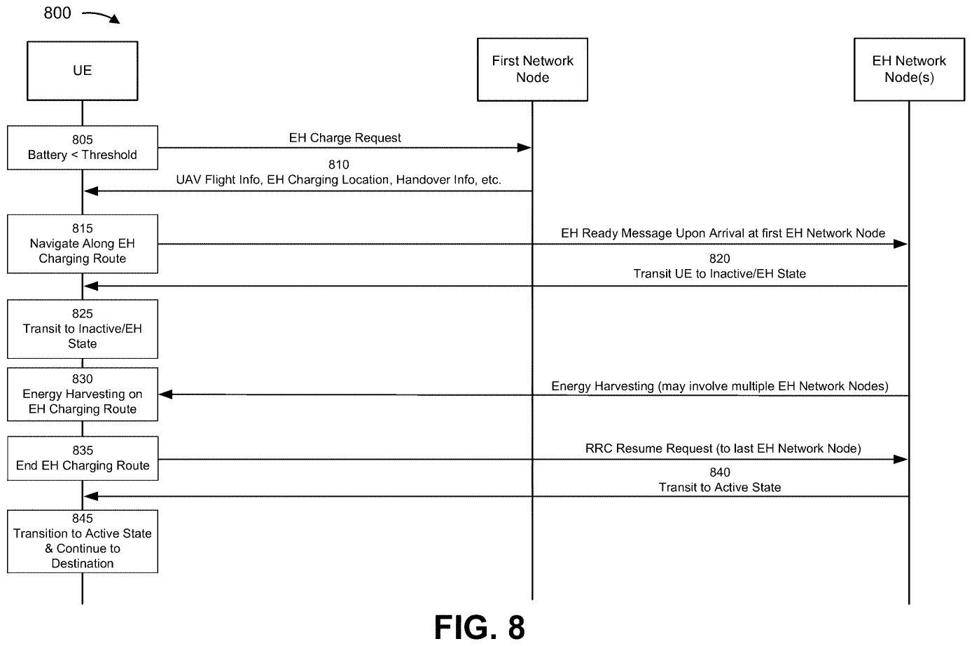

FIG. 8 is a diagram of an example 800 associated with energy harvesting for UAVs, in accordance with the present disclosure. As shown in FIG. 8, one or more network nodes may communicate with a UE (e.g., UAV UE 120). The multiple network nodes may include one or more base stations 110, one or more CUs, one or more DUs, one or more RUs, one or more core network nodes, one or more network servers, one or more application servers, and/or one or more AMFs, among other examples. In some aspects, the UE and a first network node of the multiple network nodes may be part of a wireless network (e.g., wireless network 100). The UE and the first network node may have established a wireless connection prior to operations shown in FIG. 8.

As shown by reference number 805, the UE may determine that a battery charge is below a threshold and transmit an EH charge request. The threshold may be a value indicating the amount of battery charge needed for the UE to travel to a destination along the original travel path. In some aspects, the threshold may further indicate the amount of battery charge needed for the UE to travel to the destination along the original travel path with a payload having a particular weight. The first network node may receive the EH charge request.

As shown by reference number 810, the first network node may output, and the UE may receive, information in response to the EH charge request. The information may include an updated travel path, the identification of EH charging locations, handover information if, for example, the EH charging process will be performed by a different network nodes, such as one or more EH network nodes of the multiple network nodes, and/or a combination thereof, or the like. In the example 800 of FIG. 8, the updated travel path may include multiple EH charging locations and multiple EH network nodes.

As shown by reference number 815, the UE may travel to the closest EH charging location (also called a “first EH charging location”) received via the information at reference number 810. In implementations where the UE is a UAV, the UE may fly to the first EH charging location along the updated travel path configured by the first network node. In implementations where the UE is a terrestrial vehicle, such as a personal or commercial automobile, truck, an autonomous vehicle, and/or the like, the UE may drive or navigate to the first EH charging location along the updated travel path. Upon arrival at the first EH charging location, the UE may transmit an EH ready message to the EH network node at the first EH charging location (referred to as the “first EH network node”) that will perform the EH charging process while the UE is at the first EH charging location. In some aspects, the first EH network node is the first network node. The first EH network node may be the first network node if the first network node is a type-1 or type-2 gNB. In some aspects, the first EH network node is a different network node than the first network node. The first EH network node may be different from the first network node if the first network node is a type-0 gNB. In some aspects, the first EH network node may be a different network node than the first network node if the first network node is too far from the original travel path. For example, even if the first network node is a type-1 or type-2 gNB, in some instances, the UE may be able to charge and arrive at the destination faster by traveling to a different network node rather than by traveling to the first network node. This may occur if, for example, the UE has already passed the first network node and returning to the first network node for the EH charging process would take more time than proceeding to a different network node for the EH charging process.

As shown by reference number 820, the first EH network node may configure and output, and the UE may receive, signaling that causes the UE to operate in an inactive or EH state. In some aspects, the signaling configured and output by the first EH network node to cause the UE to operate in the inactive or EH state may include RRC signaling. Certain functionality of the UE may be limited while the UE is operating in the inactive or EH state. For example, certain UL and DL communications to and from the UE may be limited while the UE is operating in the inactive or EH state. In some aspects, mobility of the UE may be limited while the UE is operating in the inactive or EH state. For example, the UE may be configured to travel at a lower speed while operating in the inactive or EH state.

As shown by reference number 825, the UE transitions to the inactive or EH state. The UE may configure itself to operate in the inactive or EH state based at least in part on the configuration signaling received (as described above with respect to reference number 820). As discussed above, certain functionality of the UE may be limited while the UE is operating in the inactive or EH state.

As shown by reference number 830, the UE and the first EH network node may begin the EH charging process. During the EH charging process, energy output by the first EH network node wirelessly charges the battery of the UE. In some aspects, the EH charging process may continue until the UE enters a new EH charging location associated with the next EH network node along the updated travel path. In that instance, the UE may continue the EH charging process with the next EH network node. In some aspects, a handoff may occur each time the UE enters a new EH charging location. In some aspects, the EH charging process may continue until the battery of the UE is fully charged, until an amount of time indicated by the timer length value has elapsed, or the UE, the UE travels through the last EH charging location of the updated travel path, and/or the EH network node otherwise discontinue the EH charging process.

As shown by reference number 835, the UE may output, and the last EH network node along the updated travel path may receive, a resume request. In some aspects, the UE may output the resume request to the last EH network node when the battery of the UE has been fully charged. In some aspects, the UE may output the resume request to the last EH network node when the UE has exited or is about to exit the last EH charging location along the updated travel path. In some aspects, the resume request may be communicated via RRC signaling. In some aspects, the resume request may indicate to the last EH network node that the UE is going to exit the EH charging process and continue to the destination of the original travel path.

As shown by reference number 840, the last EH network node may output, and the UE may receive, configuration signaling to transition to an active state. The configuration signaling may occur in accordance with the resume request discussed above with regard to reference number 835. For example, in some aspects, the last EH network node may output the signaling to transition the UE to the active state as a result of receiving the resume request. In some aspects, the configuration signaling may be RRC signaling.

As shown by reference number 845, the UE may transition from the inactive or EH state to the active state. In some aspects, the UE may configure itself to operate in the active state in response to the configuration signaling received at reference number 840. When operating in the active state, the UE may continue to the destination of the original travel path. In some aspects, the UE may return to the original travel path before continuing to the destination. In some aspects, the UE may proceed along a new travel path to the destination.

With the above approach, the UE has an opportunity to charge its battery and reach its target destination without stopping. Accordingly, the UE can travel farther than if it were limited to a range associated with a single battery charge. Moreover, by transitioning to an inactive or EH state, the UE can use less energy during the EH charging process, which may permit the UE to charge faster than if it were operating at full functionality or speed (e.g., the active state).

As indicated above, FIG. 8 is provided as an example. Other examples may differ from what is described with respect to FIG. 8.

In some aspects, the UAV UE 120 and the network node 110 may apply an EH switching procedure to switch between a static EH process (such as the EH process discussed above with respect to example 700 of FIG. 7) and a dynamic EH process (such as the EH process discussed above with respect to example 800 of FIG. 8) since the different types of EH processes have different advantages. For example, the static EH process may have higher charging efficiency than the dynamic EH process. On the other hand, traveling time and overall energy consumption may be lower with the dynamic EH process.

In some aspects, the network node 110, the UAV UE 120, and/or a combination of both, may determine if the energy charged per unit time during the dynamic EH process is less than the energy spent per unit time performing the dynamic EH process. In that circumstance, the UAV UE 120 may transmit a request to the network node 110 to switch to the static EH process. In response, the network node 110 may direct the UAV UE 120 to the EH network node, such as a type 1 or type 2 gNB, for static EH.

In some aspects, to increase charging efficiency, the network node 110 may configure the UAV UE 120 with a dedicated RU resource, configure a high antenna power or transmit (Tx) power for the EH process, dedicate antenna (ports) of the gNB RU for the EH process, and/or a combination thereof, among other examples.

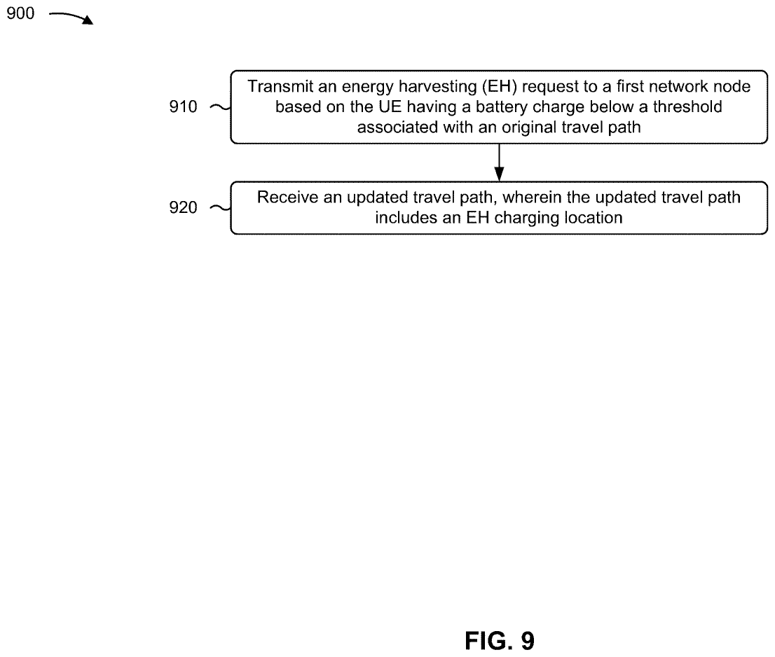

FIG. 9 shows a method 900 for wireless communications by a UE, such as UAV UE 120.

Method 900 begins at 910 transmitting an EH request to a first network node based on the UE having a battery charge below a threshold associated with an original travel path.

Method 900 then proceeds to step 920 with receiving an updated travel path, wherein the updated travel path includes an EH charging location.

In one aspect, one of the first network node or a second network node is located at the EH charging location.

In one aspect, method 900 further includes transmitting an EH ready message to the one of the first network node or the second network node located at the EH charging location.

In one aspect, transmitting the EH ready message occurs after the UE arrives at the EH charging location.

In one aspect, method 900 further includes receiving, as a result of transmitting the EH ready message, signaling from the one of the first network node or the second network node located at the EH charging location to transition from an active state to an inactive state.

In one aspect, the signaling configures the UE to reduce a traveling speed from an operating speed to an EH charging speed.

In one aspect, method 900 further includes receiving an EH end message from the one of the first network node or the second network node located at the EH charging location.

In one aspect, the EH end message is received via an energy envelope command.

In one aspect, the EH end message is received via radio resource control signaling and configures the UE to transition from an inactive state to an active state.

In one aspect, method 900 further includes transmitting a timer length value, indicating a charging time period, to the one of the first network node or the second network node located at the EH charging location.

In one aspect, method 900 further includes receiving signaling from the one of the first network node or the second network node located at the EH charging location to transition from an inactive state to an active state.

In one aspect, the signaling configures the UE to increase a traveling speed from an EH charging speed to an operating speed.

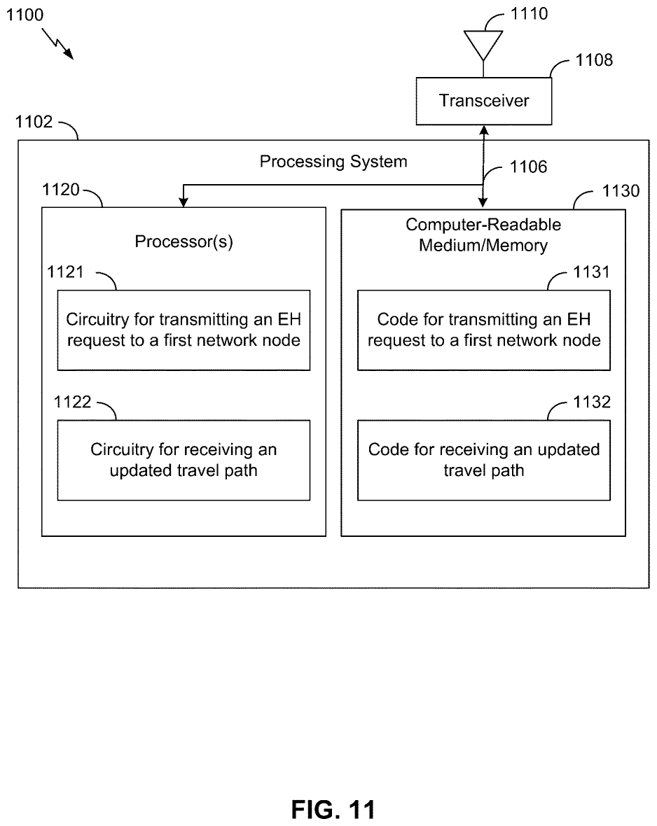

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are consistent with this disclosure.

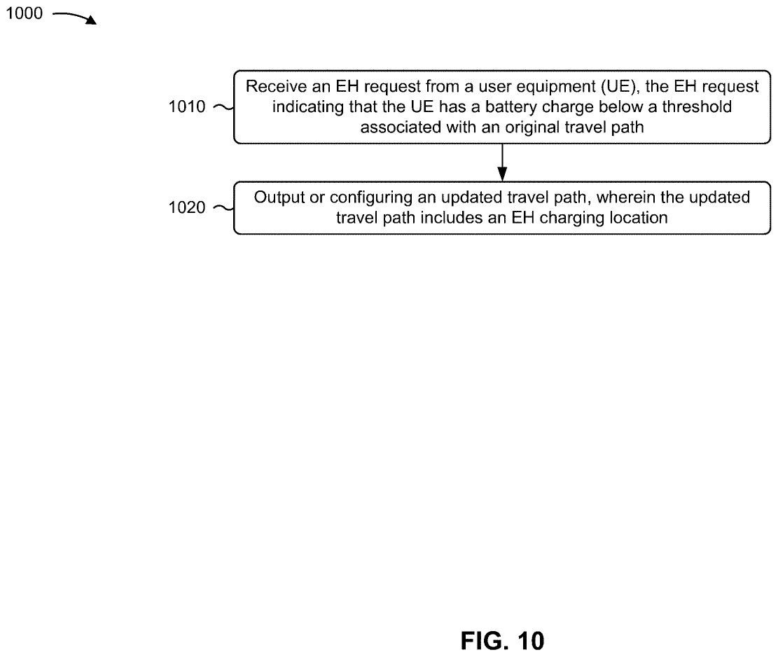

FIG. 10 shows a method 1000 for wireless communications by a network entity, such as BS 110, or a disaggregated base station as discussed with respect to FIG. 3.

Method 1000 begins at 1010 with receiving an EH request from a UE, the EH request indicating that the UE has a battery charge below a threshold associated with an original travel path.

Method 1000 then proceeds to step 1020 with outputting or configuring an updated travel path, wherein the updated travel path includes an EH charging In one aspect, method 1000 further includes receiving an EH ready message indicating that the UE is at the EH charging location.

In one aspect, method 1000 further includes outputting or configuring, as a result of receiving the EH ready message, signaling for the UE to transition from an active state to an inactive state.

In one aspect, method 1000 further includes outputting or configuring, as a result of receiving the EH ready message, signaling for the UE to reduce a traveling speed from an operating speed to an EH charging speed.

In one aspect, method 1000 further includes outputting or configuring an EH end message.

In one aspect, the EH end message is output via an energy envelope command.

In one aspect, the EH end message includes signaling for the UE to transition from an inactive state to an active state.

In one aspect, the EH end message includes signaling for the UE to increase a traveling speed from an EH charging speed to an operating speed.

In one aspect, a charging time period is configured by the network node.

In one aspect, method 1000 further includes receiving a timer length value from the UE, wherein the timer length value indicates the charging time period.

In one aspect, outputting or configuring the updated travel path includes instructing the UE to navigate closer to the network node.

In one aspect, outputting or configuring the updated travel path includes instructing the UE to stop at the network node.

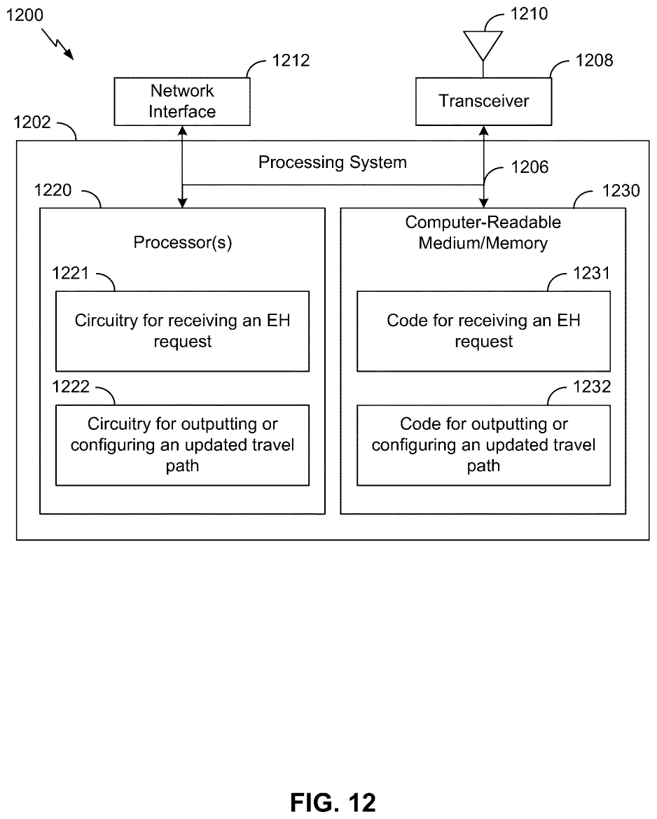

In one aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative steps are possible consistent with this disclosure.

FIG. 11 is a diagram illustrating an example of an implementation of code and circuitry for a communications device 1100, in accordance with the present disclosure. The communications device 1100 may be a UE, or a UE may include the communications device 1100.

The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes one or more processors 1120. In various aspects, the one or more processors 1120 may be representative of one or more of receive processor 258, transmit processor 264, TX MIMO processor 266, and/or controller/processor 280, as described with respect to FIG. 2. The one or more processors 1120 are coupled to a computer-readable medium/memory 1130 via a bus 1106. In various aspects, the computer-readable medium/memory 1130 may be representative of memory 282, as described with respect to FIG. 2. In certain aspects, the computer-readable medium/memory 1130 is configured to store instructions (e.g., computer-executable code, processor-executable code) that when executed by the one or more processors 1120, cause the one or more processors 1120 to perform the method 900 described with respect to FIG. 9, or any aspect related to it. Note that reference to a processor performing a function of communications device 1100 may include one or more processors performing that function of communications device 1100.

As shown in FIG. 11, the communications device 1100 may include circuitry for transmitting an EH request to a first network node based on the UE having a battery charge below a threshold associated with an original travel path (circuitry 1121).

As shown in FIG. 11, the communications device 1100 may include, stored in computer-readable medium/memory 1130, code for transmitting an EH request to a first network node based on the UE having a battery charge below a threshold associated with an original travel path (code 1131).

As shown in FIG. 11, the communications device 1100 may include circuitry for receiving an updated travel path, wherein the updated travel path includes an EH charging location (circuitry 1122).

As shown in FIG. 11, the communications device 1100 may include, stored in computer-readable medium/memory 1130, code for receiving an updated travel path, wherein the updated travel path includes an EH charging location (code 1132).

Various components of the communications device 1100 may provide means for performing the method 900 described with respect to FIG. 9, or any aspect related to it. For example, means for transmitting, sending, or outputting for transmission may include the transceiver(s) 254 and/or antenna(s) 252 of the UE 120 and/or transceiver 1108 and antenna 1110 of the communications device 1100 in FIG. 11. Means for receiving or obtaining may include the transceiver(s) 254 and/or antenna(s) 252 of the UE 120 and/or transceiver 1108 and antenna 1110 of the communications device 1100 in FIG. 11.

FIG. 11 is provided as an example. Other examples may differ from what is described in connection with FIG. 11.

FIG. 12 is a diagram illustrating an example of an implementation of code and circuitry for a communications device 1200, in accordance with the present disclosure. The communications device 1200 may be a network node (such as BS 110 or a disaggregated base station as described with regard to FIG. 3), or a network node may include the communications device 1200.

The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The network interface 1212 is configured to obtain and send signals for the communications device 1200 via communications link(s), such as a backhaul link, midhaul link, and/or fronthaul link as described herein, such as with respect to FIG. 3. The processing system 1202 may be configured to perform processing functions for the communications device 1200, including processing signals received and/or to be transmitted by the communications device 1200.

The processing system 1202 includes one or more processors 1220. In various aspects, the one or more processors 1220 may be representative of one or more of receive processor 238, transmit processor 220, TX MIMO processor 230, and/or controller/processor 240, as described with respect to FIG. 2. The one or more processors 1220 are coupled to a computer-readable medium/memory 1230 via a bus 1206. In various aspects, the computer-readable medium/memory 1230 may be representative of memory 242, as described with respect to FIG. 2. In certain aspects, the computer-readable medium/memory 1230 is configured to store instructions (e.g., computer-executable code, processor-executable code) that when executed by the one or more processors 1220, cause the one or more processors 1220 to perform the method 1000 described with respect to FIG. 10, or any aspect related to it. Note that reference to a processor performing a function of communications device 1200 may include one or more processors performing that function of communications device 1200.

As shown in FIG. 12, the communications device 1200 may include circuitry for receiving an EH request from a UE, the EH request indicating that the UE has a battery charge below a threshold associated with an original travel path (circuitry 1221).

As shown in FIG. 12, the communications device 1200 may include, stored in computer-readable medium/memory 1230, code for receiving an EH request from a UE, the EH request indicating that the UE has a battery charge below a threshold associated with an original travel path (code 1231).

As shown in FIG. 12, the communications device 1200 may include circuitry for outputting or configuring an updated travel path, wherein the updated travel path includes an EH charging location (circuitry 1222).

As shown in FIG. 12, the communications device 1200 may include, stored in computer-readable medium/memory 1230, code for outputting or configuring an updated travel path, wherein the updated travel path includes an EH charging location (code 1232).

Various components of the communications device 1200 may provide means for performing the method 1000 described with respect to FIG. 10, or any aspect related to it. For example, means for transmitting, sending, or outputting for transmission may include the transceiver(s) 232 and/or antenna(s) 234 of the BS 110 and/or transceiver 1208 and antenna 1210 of the communications device 1200 in FIG. 12. Means for receiving or obtaining may include the transceiver(s) 232 and/or antenna(s) 234 of the BS 110 and/or transceiver 1208 and antenna 1210 of the communications device 1200 in FIG. 12.

FIG. 12 is provided as an example. Other examples may differ from what is described in connection with FIG. 12.

The following provides an overview of some Aspects of the present disclosure:

Aspect 1: A method of wireless communication performed by a UE, comprising: transmitting an EH request to a first network node based on the UE having a battery charge below a threshold associated with an original travel path; and receiving an updated travel path, wherein the updated travel path includes an EH charging location.

Aspect 2: The method of Aspect 1, wherein one of the first network node or a second network node is located at the EH charging location.

Aspect 3: The method of Aspect 2, further comprising transmitting an EH ready message to the one of the first network node or the second network node located at the EH charging location.

Aspect 4: The method of Aspect 3, wherein transmitting the EH ready message occurs after the UE arrives at the EH charging location.

Aspect 5: The method of Aspect 3, further comprising receiving, as a result of transmitting the EH ready message, signaling from the one of the first network node or the second network node located at the EH charging location to transition from an active state to an inactive state.

Aspect 6: The method of Aspect 5, wherein the signaling configures the UE to reduce a traveling speed from an operating speed to an EH charging speed.

Aspect 7: The method of Aspect 2, further comprising receiving an EH end message from the one of the first network node or the second network node located at the EH charging location.

Aspect 8: The method of Aspect 7, wherein the EH end message is received via an energy envelope command.

Aspect 9: The method of Aspect 7, wherein the EH end message is received via radio resource control signaling and configures the UE to transition from an inactive state to an active state.

Aspect 10: The method of Aspect 7, further comprising transmitting a timer length value, indicating a charging time period, to the one of the first network node or the second network node located at the EH charging location.

Aspect 11: The method of Aspect 2, further comprising receiving signaling from the one of the first network node or the second network node located at the EH charging location to transition from an inactive state to an active state.

Aspect 12: The method of Aspect 11, wherein the signaling configures the UE to increase a traveling speed from an EH charging speed to an operating speed.

Aspect 13: A method of wireless communication performed by a network node, comprising: receiving an EH request from a UE, the EH request indicating that the UE has a battery charge below a threshold associated with an original travel path; and outputting or configuring an updated travel path, wherein the updated travel path includes an EH charging location.

Aspect 14: The method of Aspect 13, further comprising receiving an EH ready message indicating that the UE is at the EH charging location.

Aspect 15: The method of Aspect 14, further comprising outputting or configuring, as a result of receiving the EH ready message, signaling for the UE to transition from an active state to an inactive state.

Aspect 16: The method of Aspect 14, further comprising outputting or configuring, as a result of receiving the EH ready message, signaling for the UE to reduce a traveling speed from an operating speed to an EH charging speed.

Aspect 17: The method of any of Aspects 13-16, further comprising outputting or configuring an EH end message.

Aspect 18: The method of Aspect 17, wherein the EH end message is output via an energy envelope command.

Aspect 19: The method of Aspect 17, wherein the EH end message includes signaling for the UE to transition from an inactive state to an active state.

Aspect 20: The method of Aspect 17, wherein the EH end message includes signaling for the UE to increase a traveling speed from an EH charging speed to an operating speed.

Aspect 21: The method of any of Aspects 13-20, wherein a charging time period is configured by the network node.

Aspect 22: The method of Aspect 21, further comprising receiving a timer length value from the UE, wherein the timer length value indicates the charging time period.

Aspect 23: The method of any of Aspects 13-22, wherein outputting or configuring the updated travel path includes instructing the UE to navigate closer to the network node.

Aspect 24: The method of any of Aspects 13-23, wherein outputting or configuring the updated travel path includes instructing the UE to stop at the network node.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a +c, b+c, and a+b+c, as well as any combination with multiples of the same element (e.g., a+a, a+a+a, a +a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication performed by a user equipment (UE), comprising:
transmitting an energy harvesting (EH) request to a first network node based on the UE having a battery charge below a threshold associated with an original travel path; and
receiving an updated travel path, wherein the updated travel path includes an EH charging location.

2. The method of claim 1, wherein one of the first network node or a second network node is located at the EH charging location.

3. The method of claim 2, further comprising transmitting an EH ready message to the one of the first network node or the second network node located at the EH charging location.

4. The method of claim 3, wherein transmitting the EH ready message occurs after the UE arrives at the EH charging location.

5. The method of claim 3, further comprising receiving, as a result of transmitting the EH ready message, signaling from the one of the first network node or the second network node located at the EH charging location to transition from an active state to an inactive state.

6. The method of claim 5, wherein the signaling configures the UE to reduce a traveling speed from an operating speed to an EH charging speed.

7. The method of claim 2, further comprising receiving an EH end message from the one of the first network node or the second network node located at the EH charging location.

8. The method of claim 7, wherein the EH end message is received via an energy envelope command.

9. The method of claim 7, wherein the EH end message is received via radio resource control signaling and configures the UE to transition from an inactive state to an active state.

10. The method of claim 7, further comprising transmitting a timer length value, indicating a charging time period, to the one of the first network node or the second network node located at the EH charging location.

11. The method of claim 2, further comprising receiving signaling from the one of the first network node or the second network node located at the EH charging location to transition from an inactive state to an active state.

12. The method of claim 11, wherein the signaling configures the UE to increase a traveling speed from an EH charging speed to an operating speed.

13. A method of wireless communication performed by a network node, comprising:
receiving an energy harvesting (EH) request from a user equipment (UE), the EH request indicating that the UE has a battery charge below a threshold associated with an original travel path; and
outputting or configuring an updated travel path, wherein the updated travel path includes an EH charging location.

14. The method of claim 13, further comprising receiving an EH ready message indicating that the UE is at the EH charging location.

15. The method of claim 14, further comprising outputting or configuring, as a result of receiving the EH ready message, signaling for the UE to transition from an active state to an inactive state, or to reduce a traveling speed from an operating speed to an EH charging speed.

16. (canceled)

17. The method of claim 13, further comprising outputting or configuring an EH end message.

18. (canceled)

19. (canceled)

20. (canceled)

21. The method of claim 13, wherein a charging time period is configured by the network node.

22. (canceled)

23. The method of claim 13, wherein outputting or configuring the updated travel path includes instructing the UE to navigate closer to the network node.

24. The method of claim 13, wherein outputting or configuring the updated travel path includes instructing the UE to stop at the network node.

25. A user equipment (UE) for wireless communication, comprising:
a memory; and
one or more processors, coupled to the memory, configured to:
transmit an energy harvesting (EH) request to a first network node based on the UE having a battery charge below a threshold associated with an original travel path; and
receive an updated travel path, wherein the updated travel path includes an EH charging location.

26. (canceled)
